(19) United States
(12) Patent Application Publication
(10) Pub. No.: US 2014/0123147 A1
(43) Pub. Date: May 1, 2014

(54) SYSTEM, METHOD, AND COMPUTER PROGRAM PRODUCT FOR PARALLEL RECONSTRUCTION OF A SAMPLED SUFFIX ARRAY

(71) Applicant: NVIDIA CORPORATION, Santa Clara, CA (US)

(72) Inventor: Jacopo Pantaleoni, Berlin (DE)

(73) Assignee: NVIDIA CORPORATION, Santa Clara, CA (US)

(21) Appl. No.: 13/666,866

(22) Filed: Nov. 1, 2012

(51) Int. Cl. G06F 17/30; G06F 9/46

(52) U.S. Cl. 718/102; 707/741; 707/E17.002

(57) ABSTRACT

A system, method, and computer program product are provided for reconstructing a sampled suffix array. The sampled suffix array is reconstructed by, for each index of a sampled suffix array for a string, calculating a block value corresponding to the index based on an FM-index, and reconstructing the sampled suffix array corresponding to the string based on the block values. Calculating at least two block values for at least two corresponding indices of the sampled suffix array is performed in parallel.

### FIELD OF THE INVENTION

The present invention relates to parallel computing, and more particularly to list-ranking techniques.

### BACKGROUND

A suffix array is a sorted array of the suffixes of a string. A suffix array is an alternative data structure to a suffix tree. Suffix arrays are useful in algorithms related to full-text searching, bioinformatics, and data compression as well as other applications. A suffix array for a string may be generated by performing a top-down traversal of the corresponding suffix tree, A sampled suffix array is an array of a subset of the indexes stored in the suffix array for a string.

Conventional algorithms for constructing a sampled suffix array are serialized in nature and, therefore, the number of cycles required to construct the sampled suffix array is proportional to the length of the string. Thus, there is a need for addressing this issue and/or other issues associated with the prior art.

### SUMMARY

A system, method, and computer program product are provided for reconstructing a sampled suffix array. The sampled suffix array is reconstructed by, for each index of a sampled suffix array for a string, calculating a block value corresponding to the index based on an FM-index, and reconstructing the sampled suffix array corresponding to the string based on the block values. Calculating at least two block values for at least two corresponding indices of the sampled suffix array is performed in parallel.

### BRIEF DESCRIPTION OF THE DRAWINGS

FIG. 1 illustrates a parallel processing unit, according to one embodiment;

FIG. 2 illustrates the streaming multi-processor of FIG. 1, according to one embodiment;

FIG. 3 illustrates an FM-index for a string T, according to one embodiment;

FIG. 4 illustrates a suffix array and a sampled suffix array for the string T of FIG. 3, according to one embodiment;

FIG. 5 shows an example of pseudo-code for serial reconstruction of the sampled suffix array of FIG. 4 based on the FM-index of FIG. 3, according to one embodiment;

FIG. 6 shows an example of pseudo-code for parallel reconstruction of the sampled suffix array of FIG. 4 based on the FM-index of FIG. 3, according to one embodiment;

FIG. 7 illustrates a flowchart of a method for reconstructing the sampled suffix array, in accordance with one embodiment;

FIG. 8 illustrates a flowchart of a method for reconstructing the sampled suffix array, in accordance with another embodiment; and

FIG. 9 illustrates an exemplary system in which the various architecture and/or functionality of the various previous embodiments may be implemented.

### DETAILED DESCRIPTION

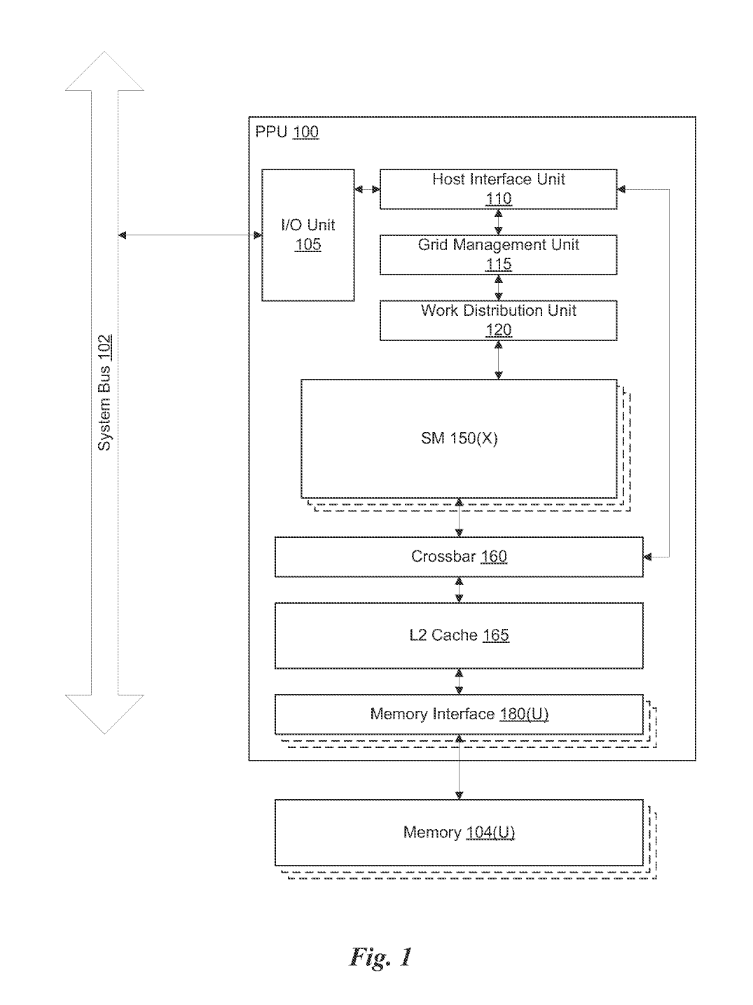

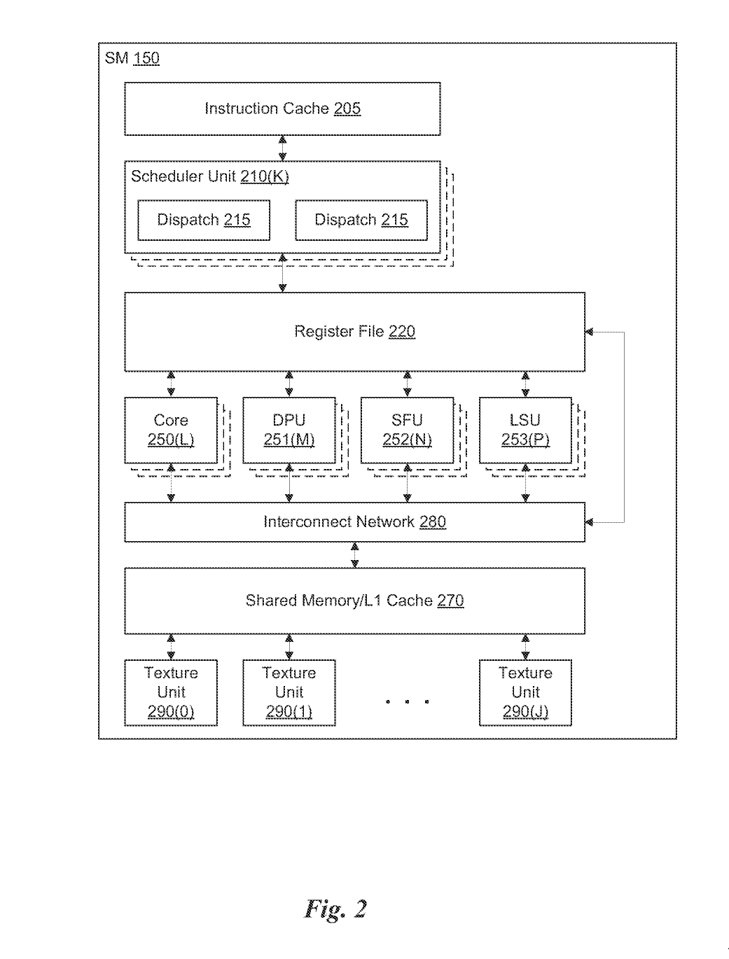

FIG. 1 illustrates a parallel processing unit (PPU) 100, according to one embodiment. While a parallel processor is provided herein as an example of the PPU 100, it should be strongly noted that such processor is set forth for illustrative purposes only, and any processor may be employed to supplement and/or substitute for the same. In one embodiment, the PPU 100 is configured to execute a plurality of threads concurrently in two or more streaming multi-processors (SMs) 150. A thread (i.e., a thread of execution) is an instantiation of a set of instructions executing within a particular SM 150, Each SM 150, described below in more detail in conjunction with FIG. 2, may include, but is not limited to, one or more processing cores, one or more load/store units (LSUs), a level-one (L1) cache, shared memory, and the like.

In one embodiment, the PPU 100 includes an input/output (110) unit 105 configured to transmit and receive communications (i.e., commands, data, etc.) from a central processing unit (CPU) (not shown) over the system bus 102. The I/O unit 105 may implement a Peripheral Component Interconnect Express (PCIe) interface for communications opera PCIe bus. In alternative embodiments, the I/O unit 105 may implement other types of well-known bus interfaces.

The PPU 100 also includes a host interface unit 110 that decodes the commands and transmits the commands to the grid management unit 115 or other units of the PPU 100 (e.g., memory interface 180) as the commands may specify. The host interface unit 110 is configured route communications between and among the various logical units of the PPU 100.

In one embodiment, a program encoded as a command stream is written to a buffer by the CPU. The buffer is a region in memory, e.g., memory 104 or system memory, that is accessible (i.e., read/write) by both the CPU and the PPU 100. The CPU writes the command stream to the buffer and then transmits a pointer to the start of the command stream to the PPU 100. The host interface unit 110 provides the grid management unit (GMU) 115 with pointers to one or more streams. The GMU 115 selects one or more streams and is configured to organize the selected streams as a pool of pending grids. The pool of pending grids may include new grids that have not vet been selected for execution and grids that have been partially executed and have been suspended.

A work distribution unit 120 that is coupled between the GMU 115 and the SMs 150 manages a pool of active grids, selecting and dispatching active grids for execution by the SMs 150. Pending grids are transferred to the active grid pool by the GMU 115 when a pending grid is eligible to execute, i.e., has no unresolved data dependencies. An active grid is transferred to the pending pool. when execution of the active grid is blocked by a dependency, When execution of a grid is completed, the grid is removed from the active grid pool by the work distribution unit 120. In addition to receiving grids from the host interface unit 110 and the work distribution unit 120, the GMU 110 also receives grids that are dynamically generated by the SMs 150 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 100. An application may include instructions (i.e., API calls) that cause the driver kernel to generate one or more grids for execution. In one embodiment, the PPU 100 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 100 comprises X SMs 150(X), For example, the PPU 100 may include 15 distinct SMs 150. Each SM 150 is multi-threaded and configured to execute a plurality of threads (e.g., 32 threads) from a particular thread block concurrently. Each of the SMs 150 is connected to a level-two (L2) cache 165 via a crossbar 160 (or other type of interconnect network). The L2 cache 165 is connected to one or more memory interfaces 180. Memory interfaces 180 implement 16, 32, 64, 128-bit data buses, or the like, for high-speed data transfer. In one embodiment, the PPU 100 comprises U memory interfaces 180(U), where each memory interface 180(U) is connected to a corresponding memory device 104(U). For example, PPU 100 may be connected to up to 6 memory devices 104, such as graphics double-data-rate, version 5, synchronous dynamic random access memory (GDDR5 SDRAM).

In one embodiment, the PPU 100 implements a multi-level memory hierarchy. The memory 104 is located off-chip in SDRAM coupled to the PPU 100. Data from the memory 104 may be fetched and stored in the L2 cache 165, which is located on-chip and is shared between the various SMs 150, In one embodiment, each of the SMs 150 also implements an L1 cache. The L1 cache is private memory that is dedicated to a particular SM 150. Each of the L1 caches is coupled to the shared L2 cache 165. Data from the L2 cache 165 may be fetched and stored in each of the L1 caches for processing in the functional units of the SMs 150.

In one embodiment, the PPU 100 comprises a graphics processing unit (GPU). The PPU 100 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system as well as attributes associated with each vertex of the primitive. The PPU 100 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes mod& data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, shader, geometry shader, pixel shader, etc. For example, the GMU 115 may configure one or more SMs 150 to execute a vertex shader program that processes a number of vertices defined by the model data. In one embodiment, the GMU 115 may configure different SMs 150 to execute different shader programs concurrently. For example, a first subset of SMs 150 may be configured to execute a vertex shader program while a second subset of SMs 150 may be configured to execute a pixel shader program. The first subset of SMs 150 processes vertex data to produce processed vertex data and writes the processed vertex data to the L2 cache 165 and/or the memory 104. After the processed vertex data is rasterized (i.e., transformed from three-dimensional data into two-dimensional data in screen space) to produce fragment data, the second subset of SMs 150 executes a pixel shader to produce processed fragment data, which is then blended with other processed fragment data and written to the frame buffer in memory 104. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 100 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 100 is embodied on a single semiconductor substrate. In another embodiment, the PPU 100 is included in a system-on-a-chip (SVC) along with one or more other logic units such as a reduced instruction set computer (RISC) CPU, a memory management unit (MMU), a digital-to-analog converter (DAC), and the like.

In one embodiment, the PPU 100 may be included on a graphics card that includes one or more memory devices 104 such as GDDR5 SDRAM. The graphics card may be configured to interface with a PCIe slot on a motherboard of a desktop computer that includes, e.g., a northbridge chipset and a southbridge chipset. In yet another embodiment, the PPU 100 may be an integrated graphics processing unit (iGPU) included in the chipset (i.e., Northbridge) of the motherboard.

FIG. 2 illustrates the streaming multi-processor 150 of FIG. 1, according to one embodiment. As shown in FIG. 2, the SM 150 includes an instruction cache 205, one or more scheduler units 210, a register file 220, one or more processing cores 250, one or more double precision units (DPUs) 251, one or more special function units (SFUs) 252, one or more load/store units (LSUs) 253, an interconnect network 280, a shared memory/L1 cache 270, and one or more texture units 290.

As described above, the work distribution unit 120 dispatches active grids for execution on one or more SMs 150 of the PPU 100. The scheduler unit 210 receives the grids from the work distribution unit 120 and manages instruction scheduling for one or more thread blocks of each active grid. The scheduler unit 210 schedules threads for execution in groups of parallel threads, where each group is called a warp. In one embodiment, each warp includes 32 threads. The scheduler unit 210 may manage a plurality of different thread blocks, allocating the thread blocks to warps for execution and then scheduling instructions from the plurality of different warps on the various functional units i.e., cores 250, DPUs 251, SFUs 252, and LSUs 253) during each clock cycle.

In one embodiment, each scheduler unit 210 includes one or more instruction dispatch units 215. Each dispatch unit 215 is configured to transmit instructions to one or more of the functional units. In the embodiment shown in FIG. 2, the scheduler unit 210 includes two dispatch units 215 that enable two different instructions from the same warp to be dispatched during each clock cycle. In alternative embodiments, each scheduler unit 210 may include a single dispatch unit 215 or additional dispatch units 215.

Each SM 150 includes a register file 220 that provides a set of registers for the functional units of the SM 150. In one embodiment, the register file 220 is divided between each of the functional units such that each functional unit is allocated a dedicated portion of the register file 220. In another embodiment, the register file 220 is divided between the different warps being executed by the SM 150. The register file 220 provides temporary storage for operands connected to the data paths of the functional units.

Each SM 150 comprises L processing cores 250. In one embodiment, the SM 150 includes a large number (e.g., 192, etc.) of distinct processing cores 250. Each core 250 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 150 also comprises M DPUs 251 that implement double-precision floating point arithmetic, N SFUs 252 that perform special functions (e.g., copy rectangle, pixel blending operations, and the like), and P LSUs 253 that implement load and store operations between the shared memory/L1 cache 270 and the register file 220. In one embodiment, the SM 150 includes 64 DPUs 251, 32 SFUs 252, and 32 LSUs 253.

Each SM 150 includes an interconnect network 280 that connects each of the functional units to the register file 220 and the shared memory/L1 cache 270. In one embodiment, the interconnect network 280 is a crossbar that can be configured to connect any of the functional units to any of the registers in the register file 220 or the memory locations in shared memory/L1 cache 270.

In one embodiment, the SM 150 is implemented within a GPU. In such an embodiment, the SM 150 comprises texture units 290. The texture units 290 are configured to load texture maps (i.e., a 2D array of texels) from the memory 104 and sample the texture maps to produce sampled texture values for use in shader programs. The texture units 290 implement texture operations such as anti-aliasing operations using mip-maps (i.e., texture maps of varying levels of detail). In one embodiment, the SM 150 includes 16 texture units 290.

The PPU 100 described above may be configured to perform highly parallel computations much faster than conventional CPUs. Parallel computing has advantages in graphics processing, data compression, biometrics, stream processing algorithms, and the like.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

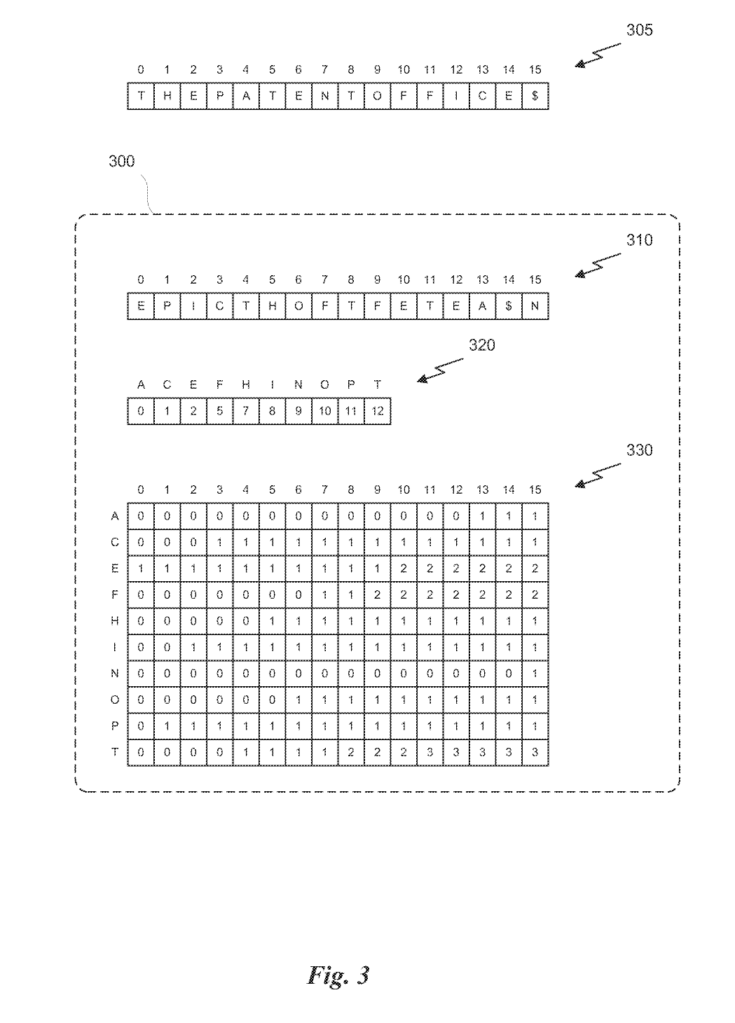

FIG. 3 illustrates an FM-index 300 for a string T 305, according to one embodiment. An FM-index (i.e., Full-text index in Minute space) is a compressed, full-text substring index based on the Burrows-Wheeler transform (BWT) of the string. As shown in FIG. 3, the FM-index 300 includes a BWT of the string, T* 310, a vector L2[aᵢ] 320, and an occurrences table O_{cc}[c,i] 330.

Given a string T 305, the BWT string T* 310 comprises a lexicographically-sorted permutation of the suffixes of the string T 305. For example, as shown in FIG. 3, the string T 305 is given as “THEPATENTOFFICE$”, where the special character ‘$’ represents an EOF (end of file) character. The corresponding BWT string T* 310 is given as “EPICTHOFTFETEA$N”. The BWT string T* 310 may be generated by creating a table where each row of the table is a rotation of the string T 305. The rows of the table are then sorted in decreasing lexicographic order. In other words, row[i] is less than row[i+1]. The characters in the last column of the sorted table comprise the BWT string T* 310.

For a string T 305 having an alphabet A comprising the set of characters {a₀, a₁, . . . , a_{b}}, the vector L2[aᵢ] 320 specifies the summed frequency of all characters in the string T 305 that have a value less than character aᵢ. For example, as shown in FIG. 3, the string T 305 has an alphabet A that includes the set of characters {‘A’, ‘C’, ‘E’, ‘F’, ‘H’, ‘I’, ‘N’, ‘O’, ‘P’, ‘T’} (the special character ‘$’ is omitted). Given this alphabet A for the string T 305, FIG. 3 shows that L2[0] is equal to zero, L2[1] is equal to one, L2[2] is equal to two, and so forth. In other words, L2[0] indicates that the frequency of characters in the string T 305 that have a value less than ‘A’ (i.e., A[0]) is zero, the frequency of characters in the string T 305 that have a value less than ‘C’ (i.e., A[1]) is one (i.e., there is one ‘A’ character), the frequency of characters in the string. T 305 that have a value less than ‘E’ (i.e., A[2]) is two (i.e., there is one ‘A’ character and one ‘C’ character), and so forth.

For a string 1305 having the alphabet A comprising the set of characters {a₀, a₁, . . . , a_{b}}, the occurrences table O_{cc}[c,i] 330 defines a two-dimensional (2D) array that specifies the number of occurrences of the character c in the substring of the BWT substring T*[0,i]. In other words, for each character c in alphabet A, the row O_{cc}[c,i] is a vector that represents the number of occurrences of character c in the BWT substring T*[0,i] of the BWT string T* 310. As shown in FIG. 3, the occurrences table O_{cc}[c,i] 330 includes 16 columns and 10 rows, corresponding to the 16 character length of the BWT string T* 310 and the 10 distinct characters comprising the BWT string T* 310, respectively. A first row of the occurrences table O_{cc}[c,i] 330 corresponds to the character ‘A’ (i.e., A[0]), and shows values of {0, 0, 0, 0, 0, 0, 0, 0, 0, 0, 0, 0, 0, 1, 1, 1} that indicate that the 14^{th} character of the BWT string T* 310 (i.e., T*[13]) is ‘A’.

In one embodiment, the FM-index 300 is compressed. For example, the BWT string T* 310, the vector L2[aᵢ] 320, and the occurrences table O_{cc}[c,i] 330 are encoded according to a compression scheme such as run-length encoding or Huffman encoding. In one embodiment, O_{cc}[c,i] 330 is encoded as a texture map, which may be compressed using techniques known to those of skill in the art. In such embodiments, the BWT string T* 310, the vector L2[aᵢ] 320, and the occurrences table O_{cc}[ci] 330 are at least partially decompressed to read a value from the FM-index 300.

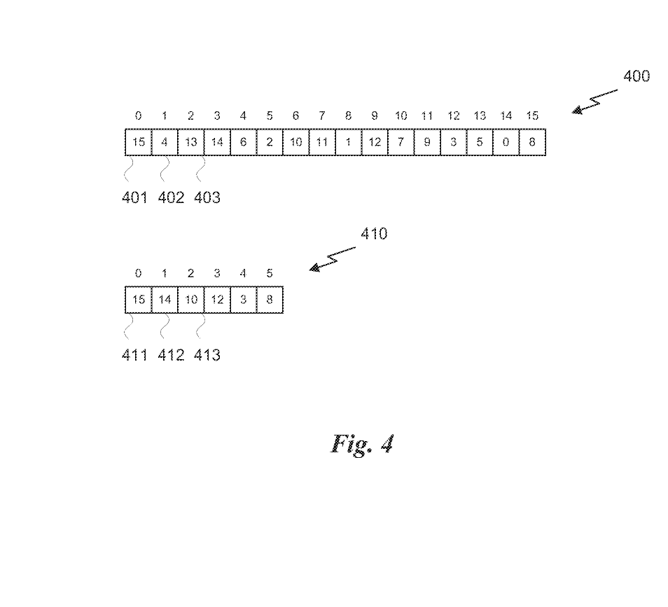

FIG. 4 illustrates a suffix array 400 and a sampled suffix array 410 for the string T 305 of FIG. 3, according to one embodiment. The suffix array (SA) 400 is a vector of indexes corresponding to the suffixes of the string T 305. For example, as shown in FIG. 4, SA[0] 401 is equal to 15 corresponding to the position of the suffix starting with the special character ‘$’, which is lexicographically the smallest value character in the string T 305. Similarly, SA[1] 402 is equal to 4 corresponding to the position of the suffix starting with the character ‘A’ (i.e., “ATENTOFFICE$”), SA‘2’ 403 is equal to 13 corresponding to the position of the suffix starting with the character ‘C’ (i.e., “CE$”), and no forth. The suffix array 400 groups like suffixes together to easily identify repeating substrings within the text of the string T 305.

Also shown in FIG. 4 is the sampled suffix array (SSA) 410, which corresponds to a subset of the full suffix array 400. In one embodiment, the sampled suffix array 410 comprises every K^{th} entry of the suffix array 400. In other words, SSA[m] is equal to SA[m*K]. For example, as shown in FIG. 4, SSA[0] 411 is equal to 15 corresponding to the position of the suffix starting with the special character ‘$’, SSA[1] 412 is equal to 14 corresponding to the position of one of the suffixes starting with the character ‘E’, SSA[2] 413 is equal to 10 corresponding to the position of the suffix starting with the character ‘F’, and so forth.

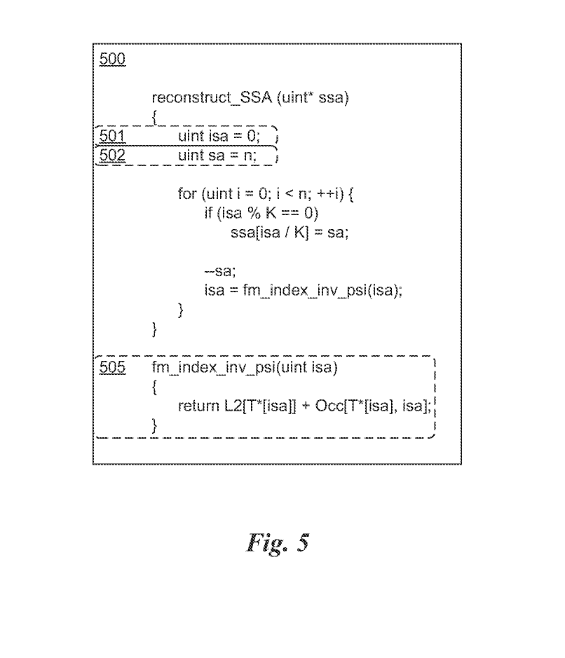

FIG. 5 shows an example of pseudo-code 500 for serial reconstruction of the sampled suffix array 410 of FIG. 4 based on the FM-index 300 of FIG. 3, according to one embodiment. Notably, the sampled suffix array 410 can be reconstructed from the BWT string T* 310, the vector L2[aᵢ] 320, and the occurrences table O_{cc}[c,i] 330. As shown in the pseudo-code 500, a first variable, isa 501, is initialized to zero and a second variable, so 502, is initialized to equal the number of characters in the string T 305, excluding the special character (e.g., 15).

A for-loop is initiated to run once for each character in the string T 305 (e.g., 15 iterations). During each iteration of the for-loop, the variable isa 501 is checked to determine if the value of isa 501 is an integer multiple of K (i.e., “isa % K==0”), where K reflects the sampling frequency of the SSA 410. If the value of isa 501 is an integer multiple of K, then the value of SSA[isa/K] is set equal to the value of variable sa 502. In other words, when the value of isa 501 is an integer multiple of K, then the value of sa 502 reflects one of the indices stored in SSA 410, However, if the value of isa 501 is not an integer multiple of K, then the value of sa 502 is not stored in the SSA 410. After the variable isa 501 is checked, the value of sa 502 is decremented by one (i.e., “—sa;”) and the value of isa 501 is set equal to the output of a deterministic function 505 of isa 501.

The deterministic function 505 adds the value of vector L2[aᵢ] to the value of the occurrences table O_{cc}[aᵢ, isa], where aᵢ is the character at the isa^{th} position of the BWT string T* 310 (i.e., T*[isa]). The deterministic function 505 of isa 501 maps each index in the BWT string T* 310 to a corresponding index in the BWT string T* 310, which is associated with the immediately preceding character in the string T 305.

The for-loop iterates as sa 502 decreases to zero, adding an index to the SSA 410 wherever the value of isa 501 is an integer multiple of K, For extremely long text strings, the serialized reconstruction algorithm may take a long time to execute as the function takes O(n) time because the value of variable isa 501 is dependent on the value of variable isa 501 during the previous iteration. Thus, for long text strings, a parallel algorithm for reconstructing the SSA 410 could reduce the processing time.

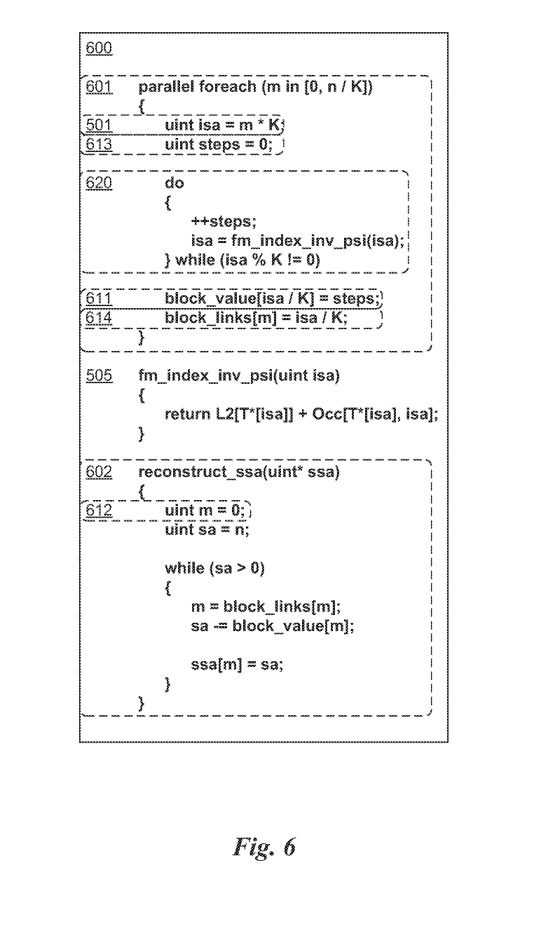

FIG. 6 shows an example of pseudo-code 600 for parallel reconstruction of the sampled suffix array 410 of FIG. 4 based on the FM-index 300 of FIG. 3, according to one embodiment. It will be apparent to one of skill in the art that the serialized algorithm illustrated by pseudo-code 504) is a generalized list-ranking operation, where the nodes in the list are positions defined by the variable isa 501. it will also be apparent to one of skill in the art that only the values of isa 501 that are an integer multiple of K are of any interest in reconstructing the SSA 410 where the value to subtract from the variable sa 502 is equal to the number of iterations (i.e., steps) taken between iterations where the value of isa 501 are integer multiples of K. other words, the list data structure generated by the serial algorithm can be divided into smaller blocks starting at indices of the list structure that are integer multiples of K. Each of the blocks can be processed in parallel to determine the number of steps between successive integer multiples of K.

As shown in FIG. 6, the parallel reconstruction algorithm is divided into a first stage 601 and a second stage 602. In the first stage 601, a block value 611 is calculated for each index m 612. The index m 612 takes each integer value in the range from zero to the length of SSA 410 (i.e,, m in [0, n/K]). The first stage 601 initializes a do-while loop 620, that executes for a number of steps 613 (i.e., iterations) while the variable isa 501 is not an integer multiple of K (i.e., iteration is stopped when the variable isa 501 is an integer multiple of K). The block value 611 for the index m 612 is set equal to the number of steps 613 completed in the do-while loop 620 until the variable isa 501 was set equal to an integer multiple of K. A block link 614 is set equal to the value of the variable isa 501 divided by K (i.e., the integer multiple associated with the corresponding value of isa 501). The first stage 601 is executed for at least two values of the index in 612 in parallel (i.e., concurrently, at least in part).

It will be appreciated that the first stage 601 determines the number of steps 613 between a particular index tn. 612 and the next value of isa 501 that is an integer multiple of K. The block value 611 can be computed independently for each index in 612 and, therefore, the first stage 601 can take advantage of parallel computing architectures to speed up processing. In one embodiment, the first stage 601 may be embodied in a shader program executed on the PPU 100 of FIG. 1. An application may define a shader program to process a plurality of index values (e.g., indices in 612). The driver kernel transmits a task to the PPU 100 that configures one or more SMs 150 to execute the shader program for different values of index m 612, concurrently.

The second stage 602 is a much-more light-weight serial loop to construct the SSA 410 using the calculated block values 611 and block links 614. Instead of iterating through every value of variable sa 502, the second stage 602 only performs one iteration for each index m 612. It will be appreciated that when K is large, the second stage 602 will reduce the number of iterations of the second stage 602 significantly over the serial reconstruction algorithm illustrated in pseudo-code 500.

In another embodiment, the second stage 602 may also be parallelized by applying any well-known list-ranking techniques such as the Wyllie algorithm, described in Wyllie, J. C. (1979), “The Complexity of Parallel Computation,” Ph.D. thesis, Department of Computer Science, Cornell University, or the Anderson-Miller algorithm, described in Anderson, Richard J.; Miller, Gary L. (1990), “A simple randomized parallel algorithm for list-ranking,”, Information Processing Letters 33, pp. 269-273, doi: 10.1016/0020-0190(90)90196-5, each of which is herein incorporated by reference in its entirety.

The parallel reconstruction algorithm illustrated by pseudo-code 600 could be extended to alternative representations of the SSA 410. In one embodiment, the SSA 410 could encode the values of the variable isa 501 instead of the values of the variable sa 502.

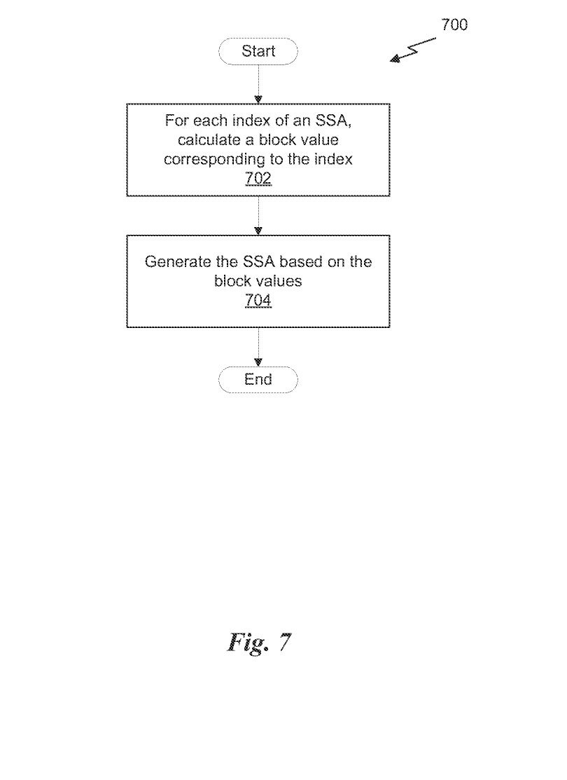

FIG. 7 illustrates a flowchart of a method 700 for reconstructing the SSA 410, in accordance with one embodiment. At step 702, the PPU 100 calculates, for each index of the SSA 410, a block value 611 corresponding to the index m 612. The block values 611 are computed in a first stage 601 of a parallel reconstruction algorithm. At step 704, the PPU 100 generates the SSA 410 based on the block values 611 calculated during step 702. in one embodiment, the SSA 410 is generated by initializing a serial loop and assigning each block value to an index of the SSA 410. In another embodiment, the SSA 410 may be generated using well-known parallel list-ranking algorithms.

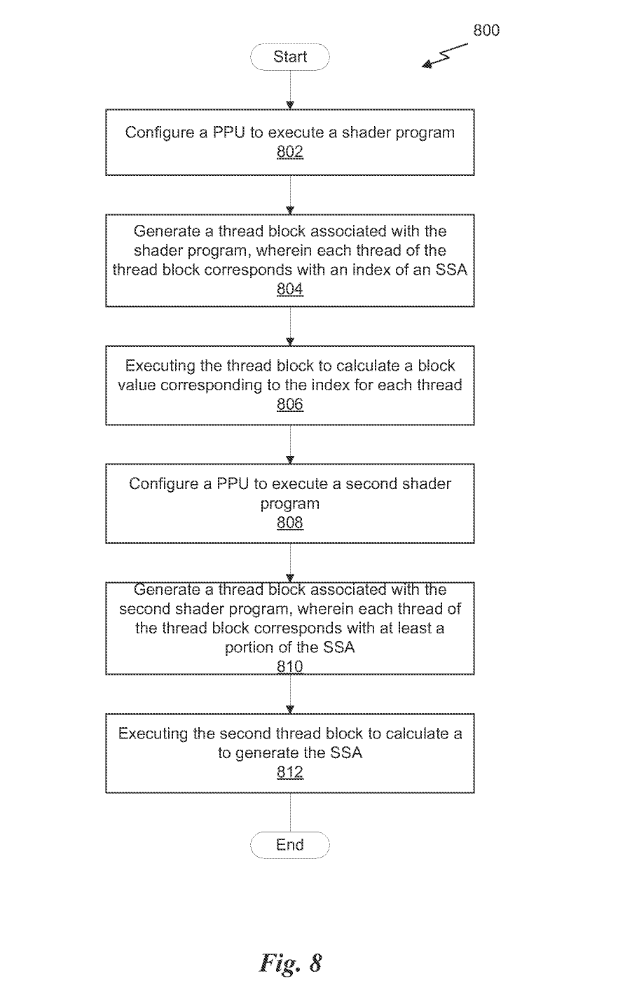

FIG. 8 illustrates a flowchart of a method 800 for reconstructing the sampled suffix array 410, in accordance with another embodiment. At step 802, the PPU 100 is configured to execute a shader program for calculating the block values 611 corresponding to indices of the SSA 410. The shader program implements the first stage 601 of the parallel reconstruction algorithm. At least one SM 150 is configured to execute the shader program. At step 804, the PPU 100 generates a thread block associated with the shader program. Each thread of the thread block corresponds to a different index in 612 of the SSA 410. At step 806, the PPU 100 executes the thread block to calculate a block value 611 corresponding to the index in 612 for each thread. It will be appreciated that multiple thread blocks may be generated and executed when the number of indices of the SSA 410 is greater than a maximum number of threads in a thread block.

At step 808, the PPU 100 is configured to execute a second shader program for generating the SSA 410. The second shader program implements the second stage 602 of the parallel reconstruction algorithm. At least one SM 150 is configured to execute the second shade/program. At step 810, the PPU 100 generates a second thread block associated with the second shader program. Each thread of the second thread block corresponds to at least a portion of the SSA 410. In one embodiment, the second thread block comprises a single thread that implements the second stage 602 as a serial loop. In another embodiment, the second thread block comprises two or more threads that implement the second stage 602 using a well-known parallel list-ranking algorithm. At step 812, the PPU 100 executes the second thread block to reconstruct the SSA 410. Again, it will be appreciated that multiple thread blocks may be generated and executed when the number of portions of the SSA 410 is greater than a maximum number of threads in a thread block.

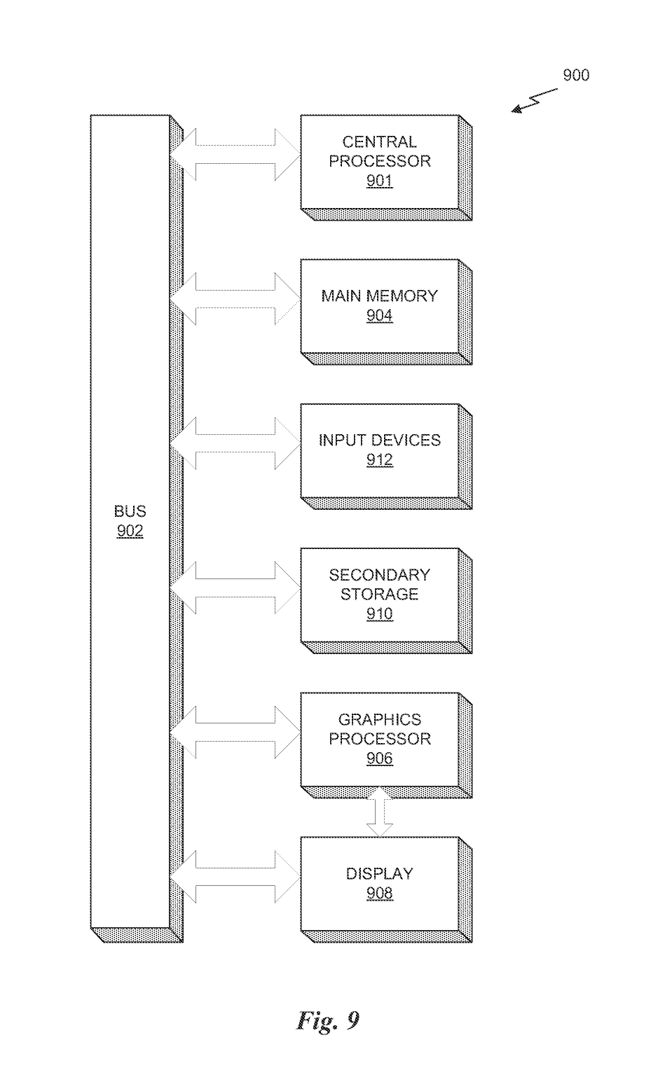

FIG. 9 illustrates an exemplary system 900 in which the various architecture and/or functionality of the various previous embodiments may be implemented. As shown, a system 900 is provided including at least one central processor 901 that is connected to a communication bus 902, The communication bus 902 may be implemented using any suitable protocol, such as Pet (Peripheral Component Interconnect), PCI-Express, AGP (Accelerated Graphics Port), HyperTransport, or any other bus or point-to-point communication protocol(s). The system 900 also includes a main memory 904. Control logic (software) and data are stored in the main memory 904 which may take the form of random access memory (RAM). In particular, the FM-index 300 may be stored in the main memory 904. As an option, the present system 900 may be implemented to carry out the method 700 of FIG. 7 or the method 800 of FIG. 8.

The system 900 also includes input devices 912, a graphics processor 906, and a display 908, i.e. a conventional CRT (cathode ray tube), LCD (liquid crystal display), LED (light emitting diode), plasma display or the like. User input may be received from the input devices 912, e.g., keyboard, mouse, touchpad, microphone, and the like. In one embodiment, the graphics processor 906 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 900 may also include a secondary storage 910. The secondary storage 910 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 904 and/or the secondary storage 910. Such computer programs, when executed, enable the system 900 to perform various functions. The memory 904, the storage 910, and/or any other storage are possible examples of computer-readable media.

In one embodiment, the architecture and/or functionality of the various previous figures may be implemented in the context of the central processor 901, the graphics processor 906, an integrated circuit (not shown) that is capable of at least a portion of the capabilities of both the central processor 901 and the graphics processor 906, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 900 may take the form of a desktop computer, laptop computer, server, workstation, game consoles, embedded system, and/or any other type of logic. Still yet, the system 900 may take the form of various other devices including, but not limited to a personal digital assistant (PDA) device, a mobile phone device, a television, etc.

Further, while not shown, the system 900 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
for each index of a sampled suffix array for a string, calculating, based on a full-text index in minute space (FM-index), a block value corresponding to the index; and
reconstructing the sampled suffix array corresponding to the string based on the block values,
wherein the calculating of at least two of the block values for at least two of the corresponding indices of the sampled suffix array is performed in parallel.

2. The method of claim 1, wherein the FM-index comprises a Burrows-Wheeler transform of the string, a vector, and an occurrences table.

3. The method of claim 2, wherein the vector specifies the frequency of each character included in the string.

4. The method of claim 3, wherein the occurrences table specifies the number of occurrences of a particular character in each substring of the Burrows-Wheeler transform of the string.

5. The method of claim 2, wherein the calculating of at least two of the block values comprises adding a value stored in the vector to a value stored in the occurrences table.

6. The method of claim 5, wherein the calculating of at least two of the block values comprises accessing a compressed version of the occurrences table and decompressing at least a portion of the occurrences table to generate the value stored in the occurrences table.

7. The method of claim 6, wherein the occurrences table is compressed via Huffman encoding.

8. The method of claim 2, wherein the occurrences table is stored as a texture map.

9. The method of claim 8, wherein the calculating of at least two of the block values comprises sampling the texture map via a texture unit in a parallel processing unit.

10. The method of claim 1, further comprising:
configuring a parallel processing unit to execute a shader program for the calculating of the at least two of the block values;
generating a thread block associated with the shader program, wherein each thread of the thread block corresponds to a different index of the sampled suffix array; and
executing the thread block on at least one streaming multiprocessor of the parallel processing unit.

11. The method of claim 10, further comprising:
configuring the parallel processing unit to execute a second shader program for reconstructing the sampled suffix array corresponding to the string;
generating a second thread block associated with the second shader program, wherein each thread of the second thread block corresponds to at least a portion of the sampled suffix array; and
executing the second thread block n at least one streaming multiprocessor of the parallel processing unit.

12. The method of claim 11, wherein two or more thread blocks are executed on two or more streaming multiprocessors of the parallel processing unit.

13. The method of claim 1, wherein the calculating of at least two of the block values comprises initializing a do-while loop.

14. The method of claim 13, wherein the do-while loop iteratively calculates a new value for a variable is a while the value of the variable is a is not an integer multiple of a constant K, and wherein the do-while loop counts a number of iterations of the do-while loop while the value of the variable is a is not an integer multiple of the constant K.

15. The method of claim 14, wherein the new value for the variable is a is calculated via a deterministic function of the variable is a, and wherein the deterministic function is based on one or more values stored in the FM-index.

16. A non-transitory computer-readable storage medium storing instructions that, when executed by a processor, cause the processor to perform steps comprising:
for each index of a sampled suffix array for a string, calculating, based on a full-text index in minute space (FM-index), a block value corresponding to the index; and
reconstructing the sampled suffix array corresponding to the string based on the block values,
wherein the calculating of at least two of the block values for at least two of the corresponding indices of the sampled suffix array is performed in parallel.

17. The non-transitory computer-readable storage medium of claim 16, wherein the FM-index comprises a Burrows-Wheeler transform of the string, a vector, and an occurrences table.

18. The non-transitory computer-readable storage medium of claim 16, the steps further comprising:
configuring a parallel processing unit to execute a shader program for the calculating of the at least two of the block values; and
executing a thread block on two or more streaming multiprocessors of the parallel processing unit, wherein each thread of the thread block corresponds to a different index of the sampled suffix array.

19. A system comprising:
a parallel processing unit; and
a memory storing instructions that configure the parallel processing unit to:
for each index of a sampled suffix array for a string, calculating, based on a full-text index in minute space (FM-index), a block value corresponding to the index, and
reconstruct the sampled suffix array corresponding to the string based on the block values;
wherein the calculating of at least two of the block values for at least two of the corresponding indices of the sampled suffix array is performed in parallel by the parallel processing unit.

20. The system of claim 19, wherein the parallel processing unit is a graphics processing unit configured to execute a shader for the calculating of the block values.
